(19) United States
(12) Patent Application Publication
(10) Pub. No.: US 2009/0177378 A1
(43) Pub. Date: Jul. 9, 2009

(54) Navigation device and method

(76) Inventors: Theo Kamalski, Waert (NL); Rijn Buve, Leiden (NL)

Correspondence Address: TOMTOM INTERNATIONAL B.V., REMBRANDTPLEIN 35, AMSTERDAM, 1017CT, NL

(21) Appl. No.: 12/007,130

(22) Filed: Jan. 7, 2008

(51) Int. Cl. G01C 21/00; G06K 9/00

(52) U.S. Cl. 701/207; 382/100; 382/181

(57) ABSTRACT

A system and method of operating a portable navigation device or navigation system having a digital camera associated therewith and controlled is described. The method includes capturing digital image data as well as performing a pattern recognition technique on the captured digital image data to determine whether the image includes one or more recognizable pre-defined features. In addition, some information is stored into memory, including an indication of a feature identified for which the pattern recognition technique was successful together with geospatial location data identifying the approximate position of at least one of: the location of the device or system when the digital image was captured, a calculated predicted location of the device and a calculated approximation of the location of the feature identified in the captured digital image.

### BACKROUND OF THE INVENTION

Portable navigation devices (PNDs) including GPS (Global Positioning System) signal reception and processing means are well known and are widely employed as in-car navigation systems. In essence, modern PNDs comprise:
a processor,
memory (at least one of volatile and non-volatile, and commonly both),
map data stored within said memory,
a software operating system and optionally one or more additional programs executing thereon, to control the functionality of the device and provide various features,
a GPS antenna by which satellite-broadcast signals including location data can be received and subsequently processed to determine a current location of the device,
optionally, electronic gyroscopes and accelerometers which produce signals capable of being processed to determine the current angular and linear acceleration, and in turn, and in conjunction with location information derived from the GPS signal, velocity and relative displacement of the device and thus the vehicle in which it is mounted,
input and output means, examples including a visual display (which may be touch sensitive to allow for user input), one or more physical buttons to control on/off operation or other features of the device, a speaker for audible output,
optionally one or more physical connectors by means of which power and optionally one or more data signals can be transmitted to and received from the device, and
optionally one or more wireless transmitters/receivers to allow communication over mobile telecommunications and other signal and data networks, for example Wi-Fi, Wi-Max GSM and the like.

The utility of the PND is manifested primarily in its ability to determine a route between a start or current location and a destination, which can be input by a user of the computing device, by any of a wide variety of different methods, for example by postcode, street name and number, and previously stored well known, favourite or recently visited destinations. Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice. In addition, the device may continually monitor road and traffic conditions, and offer to or choose to change the route over which the remainder of the journey is to be made due to changed conditions. Real time traffic monitoring systems, based on various technologies (e.g. mobile phone calls, fixed cameras, GPS fleet tracking) are being used to identify traffic delays and to feed the information into notification systems.

The navigation device may typically be mounted on the dashboard of a vehicle, but may also be formed as part of an on-board computer of the vehicle or car radio. The navigation device may also be (part of) a hand-held system, such as a PDA (Personal Navigation Device) a media player, a mobile phone or the like, and in these cases, the normal functionality of the hand-held system is extended by means of the installation of software on the device to perform both route calculation and navigation along a calculated route. In any event, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function provided, and the navigation along such a route is another primary function. During navigation along a calculated route, the PND provides visual and/or audible instructions to guide the user along a chosen route to the end of that route, that is the desired destination. It is usual for PNDs to display map information on-screen during the navigation, such information regularly being updated on-screen so that the map information displayed is representative of the current location of the device, and thus of the user or user's vehicle if the device is being used for in-car navigation. An icon displayed on-screen typically denotes the current device location, and is centred with the map information of current and surrounding roads and other map features being also displayed. Additionally, navigation information may be displayed, optionally in a status bar above, below or to one side of the displayed map information, examples of navigation information including the distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that
a user deviates from the previously calculated route during navigation therealong,
real-time traffic conditions dictate that an alternative route would be more expedient and the device is suitably enabled to recognize such conditions automatically, or
if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and taffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

More recently, PNDs have been manufactured with integrated digital cameras including one or more charge coupled devices (CCDs) and are thus capable of capturing digital photographic images which are then usually stored in the non-volatile device memory. Such images may be subsequently downloaded onto a user's PC or other digital image bank, as is conventional practice for dedicated digital cameras, by means of a physical, e.g. USB, connection between PC and device. As mentioned, the images may be stored in the native non-volatile memory within the device, or on a removable media storage card, such as a secure digital or SD card, or any other such removable digital media, e.g. flash memory. One particular advantage of integrating a digital camera into a PND is that the digital image captured may be tagged with specific location information calculated from the GPS signals being or recently received by the device, in addition to standard tag information commonly ascribed to such images, e.g. time and date. In particular, the S90i device manufactured and sold by Navman® includes this facility.

Navman® also offer a service whereby pre-geospatially tagged images of POIs are available for download from an image server, via a user's PC to which a PND is connected, and can be stored in the memory of the device for later display on the screen of the device when the device location is determined as being within a pre-determined proximity threshold of the particular POI. A further useful feature of the storage of specific geospatially tagged images of POIs is that they can be selected from memory as a means of identifying either a desired destination or as a desired waypoint along a route to an alternate, user-selected destination. This facility is broadly identical to the searching for and selection of standard POIs for which only textual information is stored as part of the map data used in the navigation, route calculation, and free-driving modes of the PND—the only difference being that the particular POI can be immediately identified on screen by the user by display of a photograph thereof.

Although such secondary or ancillary, features are advantageous and enhance overall user experience, they do not provide any enhancement to the navigation functionality provided by the device, except by expanding the number of accessible POIs.

Current map data providing companies such as TeleAtlas NV and NavTeq produce digital map data in the form of one or more base data files from which the PND extracts information which is used in the creation of graphical representations of geographical features, such as roads, buildings, railroads, and other landmarks and POIs. This information is displayed on the screen of the device, and is refreshed almost continuously, to provide the user with a continuously changing map of the current location and surrounding area with reference to a generally stationery graphical vehicle indicator also displayed in the middle of the screen. The extent of the detail shown in the map is dependent on many factors including the particular scale of the map chosen by the user, the speed of travel, and of course the level of detail provided by the underlying map data files in use for the particular locality in which the device is currently situated. For example, only relatively little information is displayed on the screen of the device when the user is traveling on a motorway through countryside, whereas relatively much greater levels of detail may be provided on-screen when the user is traveling through a city on congested roads, and thus quite slowly.

In this latter scenario, the navigation functionality provided by the device is enhanced by the display of more detailed information on-screen on account of the greater likelihood that the user can correlate road-side or road-based features displayed on-screen with the corresponding physical features which he can see as he drives along the particular road or roads in question. One disadvantage with current map provider-originated data files is that their level of detail only increases with every successive version release. As such these occur only relatively infrequently, and therefore it is possible for map information to be outdated by changes in road layouts and the implementation of access limitations often occurring in cities and to a lesser extent, in extra-urban regions. Additionally, map data does not generally include transient road alterations, such as may be caused by road works, carriageway reductions or alterations, or pedestrianization of roads previously mapped as vehicular thoroughfares.

It is an object of the present invention to provide a PND or navigation system, a method of operating such, and a computer program by means of which such are controlled, together with a map data improvement system, which allows a camera-enabled PND to use photographically captured digital information to enhance the base map data files by means of which said device provides its navigation functionality.

### BRIEF SUMMARY OF THE INVENTION

According to the present invention, there is provided a method of operating a PND or navigation system having a digital camera associated therewith by means of which digital image data can be captured, said method characterized by performing a pattern recognition technique on said captured digital image data to determine whether the image contains one or more recognizable features, said features having been previously defined by digital information stored in the memory of said device and said pattern recognition technique conducting a comparison between the captured digital image information and at least some of the digital information representative of a feature, and further characterized by the storage of at least some information including an indication of the feature identified for which the pattern recognition technique was successful together with geospatial location data identifying the approximate position of at least one of:
the location of the device at the instant when the digital image was captured or within a predetermined time threshold of that instant,
a calculated predicted location of the device at the instant the digital image was captured, said prediction being based on an earlier stored device position information, and
a calculated approximation of the location of the feature identified in the captured digital image.

Most preferably the information stored by the device after a successful pattern recognition is one or more of the particular captured digital images containing the one or more features identified therein.

Most preferably, the features for which sets of digital descriptors are provided are such features as are commonly found on, in or around modern roads, examples including pedestrian crossings, traffic lights, speed cameras, warning signs, speed limits, gantries, road markings, and the like, such being features which are easily recognizable and distinguishable, both digitally in the pattern recognition technique, and in reality by drivers of vehicles.

In a preferred embodiment, the capture of digital image data occurs substantially continuously such that a stream of digital data, more akin to a digital video feed, is captured by the PND or system, said pattern recognition technique being performed substantially continuously on said streaming digital data.

In a yet further preferred embodiment, it is preferred that only a portion, being preferably a frame, of the streaming digital data is stored, the remainder being discarded, that portion which is stored in the device or system being that portion which contains a digital representation of the feature which is successfully recognized by the pattern recognition technique.

In a yet further preferred embodiment, it is preferred that the device or system contains one or more stored graphical icons representative of the one or more features capable of being identified by said pattern recognition technique, the PND or system including a routine whereby the map information displayed on screen is augmented by the display of the graphical icons representing such features at the appropriate position, as previously determined by the PND system on capture of digital image data containing the identified feature.

In a most preferred embodiment, the first aspect of the invention forms part of a map data update system wherein the PND or navigation system stores information identifying a feature and its location, said PND or navigation system includes means for uploading such data to a data validation server which processes all received feature identification and corresponding location information, said processing taking into account the fact that some uploaded data will be erroneous and thus determining a relative likelihood that a feature exists at a particular location depending on the number of times a particular feature is identified in a particular location, or within a proximity threshold thereof, said data validation server also creating one or more map update files containing the validated feature information and corresponding location information, said map data update system then subsequently transmitting said one or more map update files containing validated feature data back to the PND or navigation system.

In one embodiment, the map update files created by the validation server contain graphical icon representations of identified features, such being displayed in superposed manner together with the base map data on the screen of the PND or navigation system.

In an alternative embodiment, the PND or system memory stores graphical icon representations of potential features which may be identified in the map update files received from the data validation server, said map update files containing only pointer information (together with corresponding location information) which is identifiable by the PND or navigation system which can thus retrieve the appropriate locally stored graphical icon for display on the device or system screen when displaying map data for an area which includes the location information in the map data update file.

Preferably the PND is provided with an integrated digital camera, or in an alternative embodiment, the PND or navigation system is associated with, and provided with software which is capable of controlling, a digital camera, which may be connected to the PND or navigation system by means of a physical (e.g. cable) or wireless (e.g. Bluetooth) connection. In a preferred embodiment, the digital camera may be detachable from the PND or navigation system.

In a preferred arrangement, the map update files may be downloaded over the internet by connecting a PND to an iinternet-connected PC by means of a USB cable, as is currently possible with most existing PNDs.

In further aspects of the invention, a computer program, embodied on computer readable media as required, is provided for implementing the methods described above, as is a PND and/or navigation system adapted to perform the methods described.

### BRIEF DESCRIPTION OF THE SEVERAL VIEWS OF THE INVENTION

The present application will be described in more detail below by using example embodiments, which will be explained with the aid of the drawings, in which:

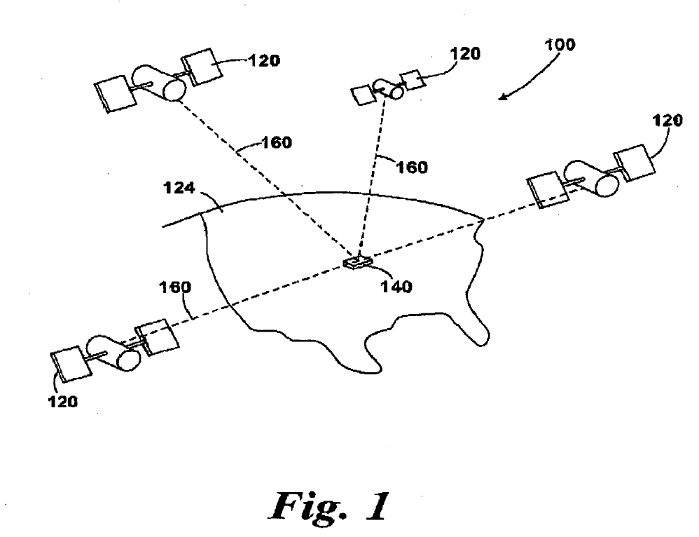

FIG. 1 illustrates an example view of a Global Positioning System (GPS);

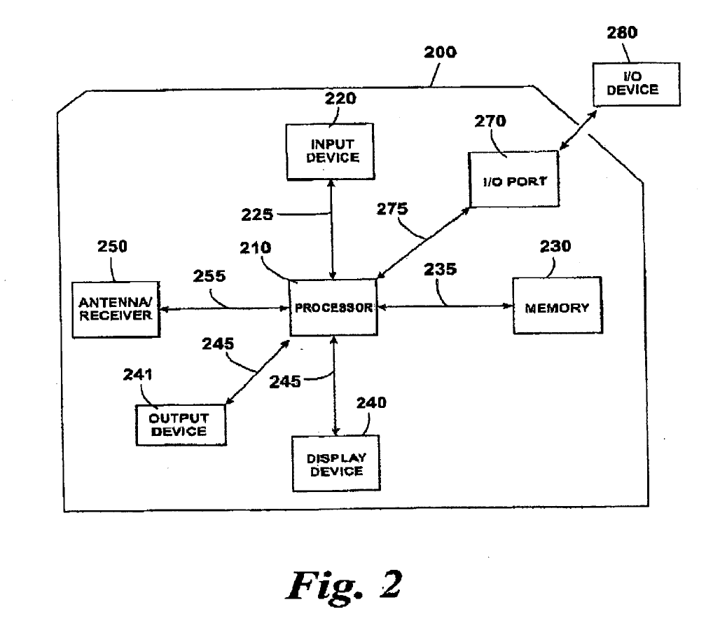

FIG. 2 illustrates an example block diagram of electronic components of a navigation device;

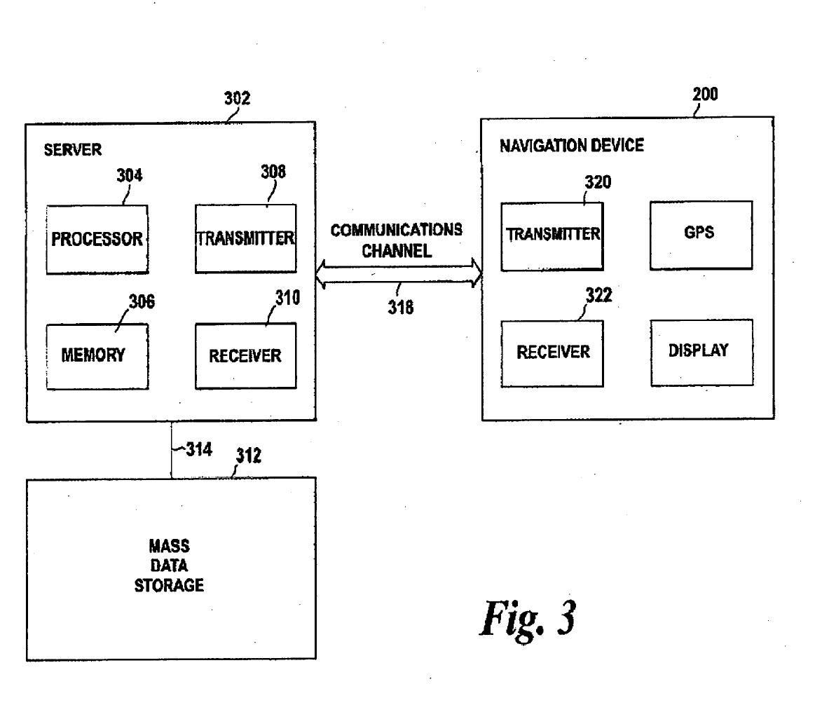

FIG. 3 illustrates an example block diagram of the manner in which a navigation device may receive information over a wireless communication channel;

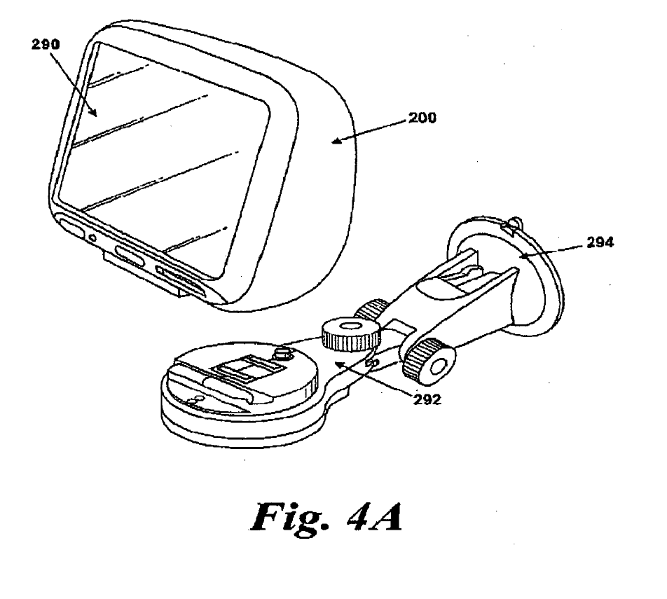

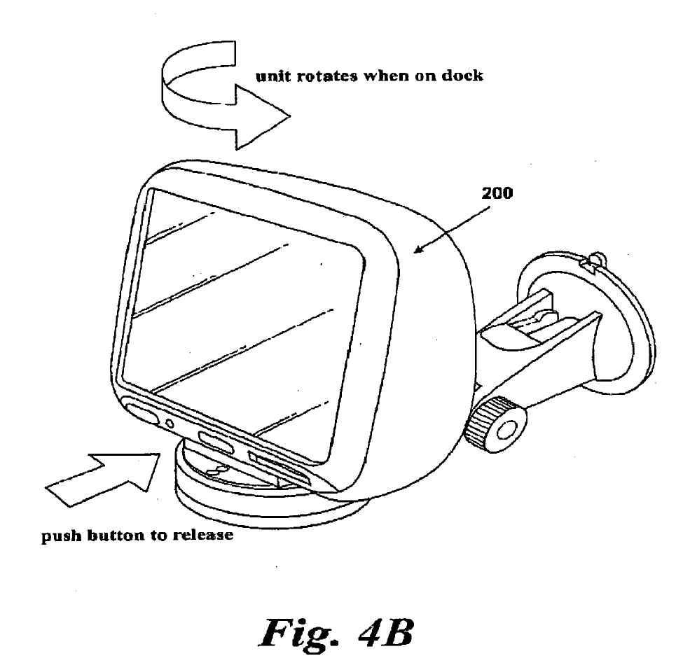

FIGS. 4A and 4B are perspective views of an implementation of an embodiment of the navigation device;

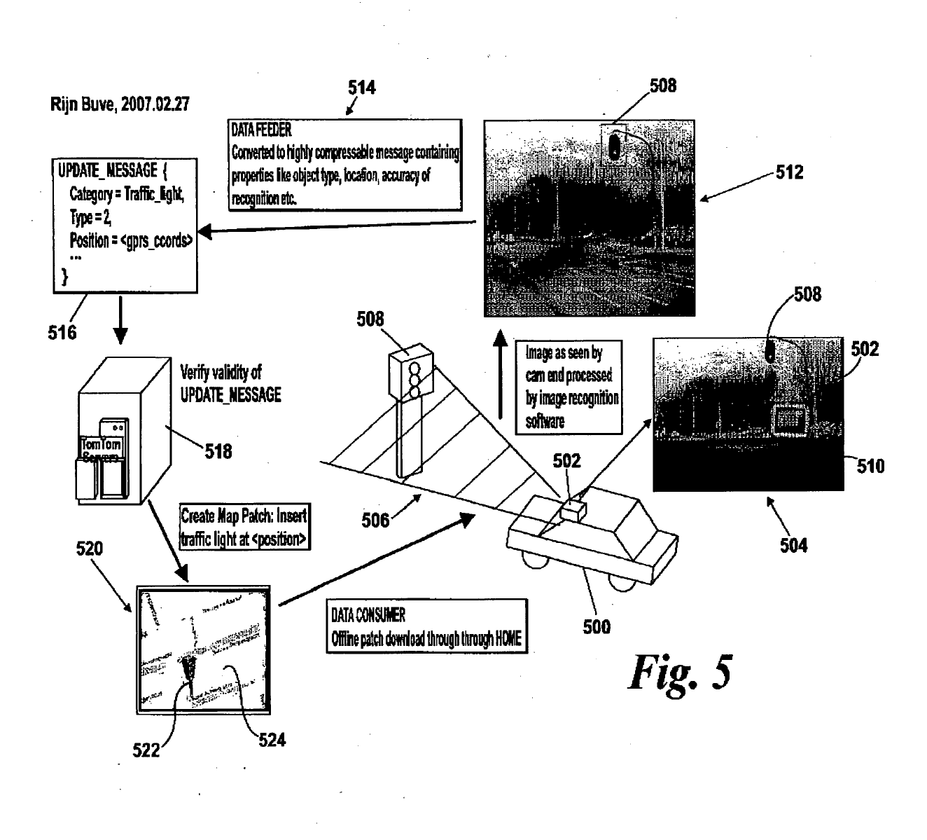

FIG. 5 shows a schematic diagram of a proposed system whereby base mad data stored locally on a PND can be augmented with graphical indicators representing user-identifiable road-side features.

### DETAILED DESCRIPTION OF THE INVENTION

FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which work with the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner. FIG. 2 illustrates an example block diagram of electronic components of a navigation device 200, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilized to input information; and the display screen 240 can include any type of display screen such as an LCD display, for example. The input device 220 and display screen 240 are integrated into an integrated input and display device, including a touchpad or touchscreen input wherein a user need only touch a portion of the display screen 240 to select one of a plurality of display choices or to activate one of a plurality of virtual buttons.

In addition, other types of output devices 250 can also include, including but not limited to, an audible output device. As output device 241 can produce audible information to a user of the navigation device 200, it is equally understood that input device 240 can also include a microphone and software for receiving input voice commands as well. In the navigation device 200, processor 210 is operatively connected to and set to receive input information from input device 240 via a connection 225, and operatively connected to at least one of display screen 240 and output device 241, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectible to an I/O device 280 external to the navigation device 200. The external I/O device 270 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

The navigation device 200 may establish a “mobile” or telecommunications network connection with the server 302 via a mobile device 400 (such as a mobile phone, PDA, and/or any device with mobile phone technology) establishing a digital connection (such as a digital connection via known Bluetooth technology for example). Thereafter, through its network service provider, the mobile device 400 can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device 400 (via a service provider) and another device such as the server 302, using the internet 410 for example, can be done in a known manner. This can include use of TCP/IP layered protocol for example. The mobile device 400 can utilize any number of communication standards such as CDMA, GSM, WAN, etc.

As such, an internet connection may be utilized which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet.

The navigation device 200 can further complete a data connection with the mobile device 400, and eventually with the internet 410 and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, wherein the internal antenna of the navigation device 200 can further alternatively be used). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet 410 for example, in a manner similar to that of any mobile device 400.

For GRPS phone settings, the Bluetooth enabled device may be used to correctly work with the ever changing spectrum of mobile phone models, manufacturers, etc., model/manufacturer specific settings may be stored on the navigation device 200 for example. The data stored for this information can be updated.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a motorized vehicle such as a car or boat for example. Such a navigation device 200 is then removable from the docked location for portable or handheld navigation use.

FIG. 3 illustrates an example block diagram of a server 302 and a navigation device 200 capable of communicating via a generic communications channel 318. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver. Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fiber optic cables, converters, radio-frequency (rf) waves, the atmosphere, empty space, etc. Furthermore, the communication channel 318 can include intermediate devices such as routers, repeaters, buffers, transmitters, and receivers, for example.

For example, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc. The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 220, etc.).

The navigation device 200 may sit on an arm 292, which itself may be secured to a vehicle dashboard/window/etc. using a large suction cup 294. This arm 292 is one example of a docking station to which the navigation device 200 can be docked. As shown in FIG. 4B, the navigation device 200 can be docked or otherwise connected to an arm 292 of the docking station by snap connecting the navigation device 292 to the arm 292 for example (this is only one example, as other known alternatives for connection to a docking station are within the scope of the present application). The navigation device 200 may then be rotatable on the arm 292, as shown by the arrow of FIG. 4B. To release the connection between the navigation device 200 and the docking station, a button on the navigation device 200 may be pressed, for example (this is only one example, as other known alternatives for disconnection to a docking station are within the scope of the present application).

Referring to FIG. 5, there is shown an overview diagram of a system according to the present invention, including a camera-enabled vehicle mounted PND. Specifically, a vehicle 500 includes a usually dash-board mounted PND 502. The typical arrangement is shown in the picture 504 in which the PND 502 can be seen, as well as the field of view 506 of the driver through the windscreen of the car, said field of view including a a traffic light 508. Ideally, the PND 502 is provided with an integrated digital camera or other digital image capture device which is operated under the control of operating software installed on the device or an alternate software program executing thereon. In a particularly desired feature of the invention, such software includes an option whereby the user may choose a conventional camera mode, in which the device is typically hand-held and used as a conventional digital camera might be used, and an alternate option wherein the device may be used in a free image-capture mode, as is envisaged in FIG. 5. In this mode of operation (which may be automatically selected by the device on determining that it is attached to its mount device indicated at 510).

In one embodiment of the invention, the digital image data is captured continuously through the camera such that as the vehicle moves, a continuous stream of digital image data, akin to streaming video is made available to the processing electronics of the device. In an alternative embodiment, the capture of digital image data occurs periodically with relatively short period, for example every few seconds, such that a sufficient amount of digital image data is captured by the device to enable a pattern or object recognition technique to be performed on that data. The particular recognition technique applied is one of many available techniques, but in principle the technique employs a set of stored digital descriptors or object definitions which describe basic and common objects such as traffic lights, street lamps, road markings and other road-based or road-side landmarks. The image or object recognition technique occurs also either periodically or continuously on the received digital image data, but in any event, the processing of captured image data gives a positive or negative result depending on whether any one of a number of objects are recognized in the captured image data at that time being processed. In the picture 512, it is seen that the traffic light feature 508 is recognized, and the device can then store a highly compressed message or other data as indicated at 514, 516 representative of both the type of object recognized and some indication of its geospatial location.

There are various options regarding the geospatial location information which is included with the object identifier in such data. One option is for the device to record the current location coordinates or GPS information at the time of capture of the digital information in which the relevant feature was identified by the pattern recognition or other image processing technique. An alternative for recording location information is to cause the device to conduct a further location processing routine based on either the device location at the time of digital image capture, or the last stored known position of the device, corrected as required to provide an approximate device location at the time of digital image capture, said further processing routine including a further image processing routine which makes an approximation of the position of the identified feature relative to the actual or approximated device location at the time of digital image capture. Of course, in all the above cases, the relevant time of digital image capture, and thus that time which determines the current actual or approximated location of the device, is that at which the digital image which is captured contains the recognized feature.

Although ideally the relevant time for determining relevant actual or approximated device position is exactly the same at which the capture of digital image data containing the recognizable feature occurred, this may not always be practicable, and of course time thresholds may apply. This will of course reduce the precision with which the current actual or approximated device location can be determined, and also, if appropriate, the derived position of the relevant recognized feature, but such reductions in accuracy may be averaged out by the overall map data update system hereinafter described.

Referring again to FIG. 5, in the device 502, when a suitable “continuous monitoring” option is enabled in which the integrated or associated digital camera continuously or periodically captures digital image data and conducts one or more pattern recognition techniques thereon, the amount of data stored will increase in proportion to the number of road-side objects identified in the captured image data. At a suitable time, for instance when the amount of update data reaches a certain size, or when the device detects a facility for communicating data with a remote server 518, either wirelessly or over a more standard USB connection to an internet-connected PC, the devices causes upload of the update information to said server which validates all received update information from all devices having a digital image capture and processing ability and which have any stored update information to provide.

The validation procedure effectively amounts to an averaging and/or other statistical procedure for all those updates received by the validation server which include location coordinates more densely distributed in one or more geographic locations than others. For example, a high distribution density of update data indicating a traffic light at or around a road intersection would certainly be suggestive of traffic lights at that intersection. On making such determination, the validation server then creates one or more map patches including graphical icons, possibly “on the fly”, and made available for later download by the entire user base of a particular device manufacturer. As can be seen at 520, which gives an example of the display of map information on a device screen, a traffic light icon 522 can be made to appear superposed on the base map data 524 in the prescribed position.

Said map patches are either downloaded from the server 518 upon request from an internet-connected PC on which software, such as that available from the applicant herefor under the TomTom HOME™ brand, has been installed and to which the device may be connected, or alternatively, in the case that the device is provided with wireless communication or telecommunication capability, over the air at predetermined times or again, on request at the behest of the user. A further alternative is that the map patches are “pushed” to the user base of devices wirelessly when the number or size of map patches reaches a certain level.

In a further alternative embodiment, the map patches may contain very limited data, for example an object indicator and corresponding location data and optionally other settings or information. In this example, it is a requirement that the PND or system contains a plurality of graphical icons stored in memory, such being selected for display in superposed relation to the displayed map data during navigation so as to provide enhanced navigation for the user. Of course, the graphical icons are only displayed when the device is proximate the location of the relevant identified object, that is at a time when the map data being displayed includes the specific location.

In summary therefore: the primary components of the system aspect of the invention are:
PND has integrated or attached or associated low-cost camera
Camera and/or device is provided with software which efficiently recognizes a predefined set of objects
Recognized objects, together with location data are sent to a validation server
Server verifies validity of recognized object and one or more map patches
Map patches are downloaded to the PND over the internet from the server, optionally wirelessly, or over other telecommunications networks.

It should be mentioned that this invention may apply equally to a vehicle integrated navigation system.

It should also be mentioned that software routines may be provided which effectively assist the user in aligning the PND in which a camera is integrated or a docking station in which the camera is provided and with which the PND connects and interfaces. Of course, in the case of a navigation system which may be provided or integrated within a motor vehicle at the time of manufacture, a camera with which the navigation system is in communication may already be provided as part of the car, and thus alignment and other issues (such as providing suitable shield from bright incoming light) may already have been taken into consideration.

There are a variety of other possibilities for the use of pattern recognition technology in PNDs and navigation systems, which are also to be considered as encompassed within the invention. For example, it is possible for camera-enabled PNDs and navigation systems to automatically create map correction data for future transmission to a validation or other back-end processing facility. In such an embodiment, the pattern recognition technique is carried out continuously or periodically on captured image data, and the types of feature which may be recognized are road junctions, layouts and arrangements, signposts indicating travel restrictions along roads and indeed any other road-based or road-side feature which may be appropriately represented by stored digital data, either being part of the underlying map data file, or a subsequent patch or POI data file commonly used in conjunction with said underlying data files.

Further specifically, in the case of automatically creating correction data applicable to the underlying map data file or ancillary data files applicable thereto, the method of the present invention includes the further step of comparing the recognized feature with underlying map data (or ancillary descriptive patch or POI data files) and identifying a discrepancy therebetween of a type which could usefully be corrected. For example, a most common difficulty with modern map information is that lesser junctions previously of a “cross-road” type are often turned into roundabout-style junctions by highway authorities, local, councils or other administrative authorities having power to change road structures and layouts in a locality. Another example may be the introduction of traffic lights or a formal junction at a previously uncontrolled junction.

By means of pattern recognition techniques carried out by the PND or navigation system, it is possible for the device to automatically determine that a particular type of junction, or traffic management measures applicable to such, as identified and displayed on screen by the device based on the underlying map data, are different from the actual junction type or traffic management measures as seen by the associated or integrated device camera when in motion, either in a free-driving or navigation mode.

This feature may be of great benefit to the overall community of device users, the majority of which are only generally interested in using the device to perform basic navigation to a desired destination, as opposed to using the map correction features which may be provided in the software of the device. Accordingly, provided that a user has already indicated that he is prepared to permit the device to automatically transmit data wirelessly from the device concerning his current or previously traveled locations (an option which is usually set at the first start up of the device), then no further action is required for the device to automatically transmit correction data.

Of course, the locally stored data, being representative of features desired to be recognized by the pattern matching technique may take any of a number of different forms, including any one or more of outline data, colour data, pattern data, appearance characteristic or profile data and the like. Additionally, the pre-stored data may include animated images which may be compared as part of the pattern recognition technique with a number of progressively captured images which together provide the effect of animation in those images.

1. A method of operating a portable navigation device or navigation system having a digital camera arranged to capture at least one digital image, the method comprising the steps of:
capturing at least one digital image;
determining, via pattern recognition, whether data of said captured image comprises one or more recognizable pre-defined features,
storing into memory information comprising identification of at least one of said features together with geospatial location data identifying an approximate position of at least one of:
a location of the device at an instant when said digital image was captured or within a predetermined time threshold of that instant,
a calculated predicated location of said device or system at an approximate instant said digital image was captured, said prediction being based on an earlier stored device position information, and
a calculated approximation of a location of said feature identified in the captured digital image.

2. The method according to claim 1, wherein said features are represented by digital information stored in the memory of the device or system, and said step of determining, via pattern recognition, further comprises the step of conducting a comparison, via pattern recognition, between said captured digital image information and at least one of said digital information representative of said feature.

3. The method according to claim 1, wherein information stored by said device or system, after successful pattern recognition, is message data identifying a recognized object together with corresponding location information relevant thereto.

4. The method according to claim 1, wherein said step of capturing further comprises the step of capturing a plurality of digital images substantially continuously such that a stream of digital data is captured by the device or system, and wherein said step of determining, via pattern recognition, further comprises the step of substantially continuously performing pattern recognition on said stream of digital data.

5. The method according to claim 1, further comprising the steps of:
storing one or more graphical icons representative of said one or more recognizable pre-defined features, and
executing a routine whereby map information displayed on a screen is augmented by a display of said graphical icons representing such features at an appropriate position, said routine using information within one or more map patch files received by the device during a download procedure.

6. The method according to claim 1, further comprising the step of comparing said recognized features with underlying map data and identifying discrepancies therebetween.

7. The method according to claim 6, wherein the subsequent storage of information an indication of said features, corresponding location data therefor, and further information indicative of an error in said underlying map data.

8. (canceled)

9. (canceled)

10. A map data update system comprising:
a portable navigation device or navigation system,
a data validation server,
wherein said device or system is arranged to upload recognized object and corresponding position data to said data validation server,
wherein said server comprises means for conducting statistical processing of said data to determine a likely veracity thereof,
wherein said data validation-server comprises means for subsequently creating one or more map patch files comprising at least recognized object data and corresponding location data for particular objects identified in the received data for which a likely existence of said recognized feature at a particular location is present,
wherein said server comprises means for executing statistical processing to determine a presence of said likely existence, and
wherein said device or system and said data validation server are arranged to establish a communication whereby said one or map patch files are returned to the device or system.

11. The system according to claim 10, wherein said device or system comprises a screen and said one or more map patch files comprise graphical icon representations of identified features, such being displayed in a superposed manner together with base map data on said screen.

12. The system according to claim 10, wherein:
said device or system comprises a memory arranged for storing graphical icon representations of potential features which may be identified in said map update files,
said map update files comprise at least indicator information together with corresponding location information,
said location information is identifiable by said device or system, and
said device or system further comprises means for retrieving locally stored graphical icon for display on said device or system screen when displaying map data for an area which includes said location information.
